(19) United States
(12) Patent Application Publication
(10) Pub. No.: US 2025/0081952 A1
(43) Pub. Date: Mar. 13, 2025

(54) Illuminating Strike Indicator for Fishing Reels

(71) Applicant: Brian Ayers, Haw River, NC (US)

(72) Inventor: Brian Ayers, Haw River, NC (US)

(21) Appl. No.: 18/824,521

(22) Filed: Sep. 4, 2024

Related U.S. Application Data
(60) Provisional application No. 63/537,011, filed on Sep. 7, 2023.

(51) Int. Cl. A01K 89/015

(52) U.S. Cl. CPC A01K 89/0179

(57) ABSTRACT

An illuminating strike indicator for fishing reels provides an electrical circuit comprising a power source and a first path connected to the power source that comprises a first control switch, a first light source, and an illumination switch in series, where the illumination switch electromechanically engages with a gear provided on a spool of the reel, such that when the first control switch is in an “on” position, the electromechanical engagement between the illumination switch and the gear provided on the spool alternately closes and opens the first path.

### CROSS-REFERENCE TO RELATED APPLICATIONS

This application claims priority to U.S. Provisional Patent Application No. 63/537,011, filed Sep. 7, 2023, which is expressly incorporated by reference herein.

### BACKGROUND OF THE INVENTION

### Field of the Invention

The present disclosure relates to fishing reels and, in particular, to providing an illuminating alert when a fish strike occurs.

### Background Art

Fishing in low light conditions—whether late at night, during the dawn or dusk hours, or in deeply shaded areas—can be very productive. In warmer seasons, fish may prefer to feed outside daylight hours when temperatures are cooler, thus improving the likelihood that a fish will accept the angler's bait. Under clear, well-lit conditions, fish may be able to see and recognize the angler and, therefore, avoid striking the bait. Thus, some anglers rely on the cover of darkness to provide an advantage; however, low light conditions can be challenging for the angler. For instance, the fisherman may not see the fish strike the line. Or, if the angler uses multiple rods simultaneously, it may be difficult or impossible to determine which rod has the strike.

To assist the angler using multiple rods, reel manufactures have added clicking mechanisms to provide an audible alert when fishing line is unspooling from the reel. While these widely-known click mechanisms encompass a variety of designs, most employ some form of a spring-biased pawl that drags across the teeth of a gear attached to the reel's spool or spool shaft—or some other gear that rotates in response to the spool's rotation—to create the clicking sound. These click pawls typically move through a limited angular rotation and are commonly biased by a spring or a spring-loaded pin that forces the tongue to remain engaged with the spool gear teeth as the spool rotates. Thus, as the spool spins to play out the fishing line in response to a running fish, the engagement between the pawl and the gear teeth provides an audible click or buzz, alerting the angler that the fish has taken the bait and is swimming away. However, these click mechanisms provide no visual alert to assist the angler during low-light conditions.

Fishermen and fishing tackle manufacturers have attempted to address the problems presented by low-light fishing. A low-tech solution is to carry a hand-held flashlight, but this requires the fisherman to secure the flashlight by hand or otherwise while simultaneously attempting to operate the rod and reel during casting, setting the hook, or landing the fish. Further, flashlights are easily misplaced on the ground or in a boat and are prone to sink if accidentally dropped into the water. Other solutions have involved headlamps worn by the angler or after-market light attachments mounted to the reel or rod, thus providing illumination to the rod, reel, or line while turned on; however, such devices are not easily activated or deactivated while the angler's hands are occupied and provide no visible alert that a fish has taken the hook.

Prior fishing reel designs have relied on illuminating the interior of the fishing reel or channeling light into a fiber-optic fishing line. For instance, U.S. Pat. No. 9,420,775 utilizes an array of light-emitting diodes (LEDs) located on a substrate located in the spool's interior to illuminate both the spool and fishing line. U.S. Pat. Nos. 7,841,757 and 7,347,607 also rely on illuminating the interior of the spool and then transmitting light to the fishing line made of specialty optical fiber or similar light-conducting filaments. Still other inventions, such as U.S. Pat. No. 6,193,387 simply place a lamp near the spool to light illuminate the spool; however, these types of devices do not provide an illuminated strike indication.

Additionally, reels designed to land large, powerful fish, such as the Penn® Squall® and Shimano® Calcutta® ranges of reels, frequently employ spools formed from solid, machined materials, including aluminum, steel, and titanium, or other high-strength materials, such as carbon composites. Such spools are typically opaque, thus necessitating an illuminating strike indication device that is not housed within or internal to the spool.

The present invention provides a solution to these and other challenges left unresolved by the prior art by providing an illumination device that begins flashing once a fish has taken the bait and continues to flash as the fish swims away, and the reel unspools additional fishing line. When utilized—as either an integrated component of a fishing reel or an aftermarket reel accessory—the invention provides an illuminating indication in the form of a flashing light that activates only once the strike has occurred and the spool begins to rotate. This assists the multi-rod angler in immediately identifying which rod has the strike. Further, the invention offers an optional second illumination function that, when switched on, allows the angler to illuminate the reel, rod, line, and surroundings—even while using both hands to reel in the fish. The present invention is self-contained, thus reducing the risk of corrosion and, unlike prior inventions, may be installed, serviced, or replaced without requiring specialty spools or fishing lines.

### BRIEF SUMMARY OF THE INVENTION

In a preferred embodiment, the invention provides a powered electronic circuit that utilizes a control switch to energize it, a momentary microswitch that closes the circuit in response to an electromechanical input from the rotating spool to illuminate a lamp.

In reels equipped with a click mechanism, the plunger of the momentary microswitch is depressed by the pawl or click tongue of the click mechanism as the pawl rides over the teeth of a gear rotating in response to the rotation of reel's spool. As the spool rotates, the gear also rotates and its teeth force the pawl to rotate through its limited angular rotation as the pawl travels over the profile of each gear tooth. As the pawl rotates outwardly in response to the gear's rotation, the pawl's outer surface, the distal end of a pawl's biasing pin used to keep the pawl engaged with the gear's teeth, or other similar structure engages and depresses the momentary microswitch's plunger, thus closing the circuit to the lamp and energizing the lamp's element, which in a preferred embodiment is a LED.

As the spool continues to rotate, the pawl rides over the top land of the gear tooth. The biasing pin or spring then forces the pawl to rotate back to its original biased position, releasing the engagement between the pawl and the momentary microswitch. This allows the microswitch's plunger to return to its original, extended position, thus opening the circuit and causing the lamp's element to turn off. Thus, the circuit will close and open each time the pawl rides over the top land of the gear teeth, causing the lamp to illuminate momentarily in a flashing effect. In this way, the lamp illuminates in sequence with the audible click provided by the click mechanism at a rate proportional to the rotational speed of the spool. For reels that do not include a click mechanism but utilize a main gear on the spool shaft, the momentary microswitch may be positioned such that its plunger directly engages the main gear's teeth as the spool shaft rotates, whether through direct contact or through an intermediate linkage. The passing of each gear tooth momentarily depresses the microswitch's plunger, closing the circuit and illuminating the lamp, before passing the plunger and allowing it to return to its normal extended position, thus opening the circuit and turning off the lamp.

### BRIEF DESCRIPTION OF THE DRAWINGS

Several embodiments of the invention will now be described in detail with reference to the accompanying drawings, wherein similar elements are referred to with similar reference numerals.

FIG. 1 is a left-side overall perspective view of the preferred embodiment of the illuminated strike indicator in use with a common fishing rod and reel.

FIG. 2 is a right-side perspective view of a common fishing reel shown in partially-exploded arrangement to reveal the placement and operation of the first embodiment of the illuminated strike indicator shown in FIG. 1.

FIG. 3 is a partially cutaway view of the embodiment shown in FIG. 2.

FIG. 4 is a schematic diagram for the electrical circuitry of the preferred embodiment shown in FIGS. 1-3.

### DETAILED DESCRIPTION OF THE INVENTION

The singular terms “a,” “an,” and “the” include plural referents unless context clearly indicates otherwise. The term “comprises” means “includes.” In case of conflict, the present specification, including explanations of any terms, will control.

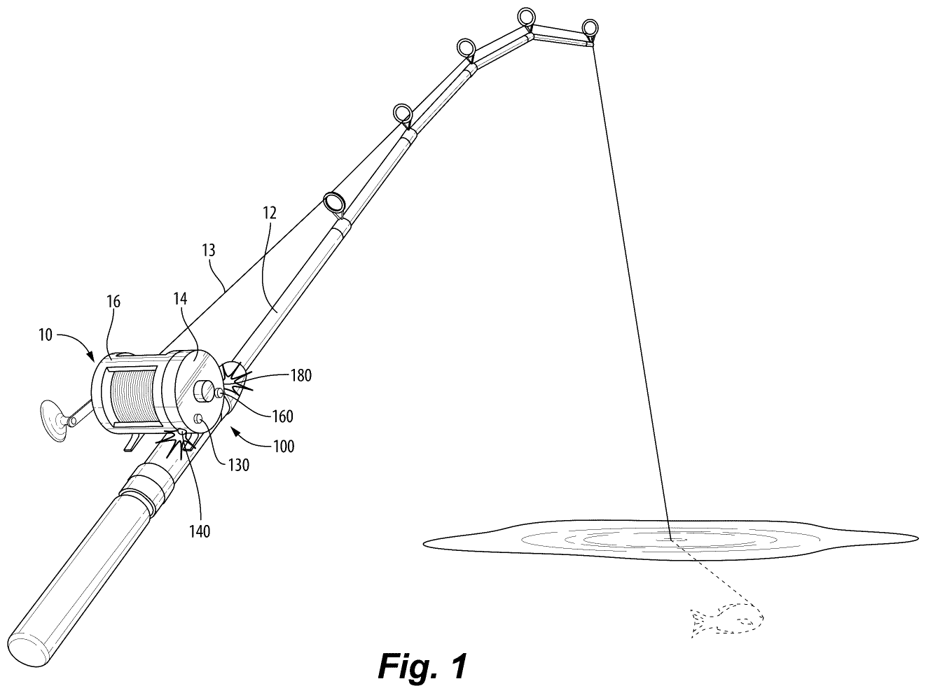

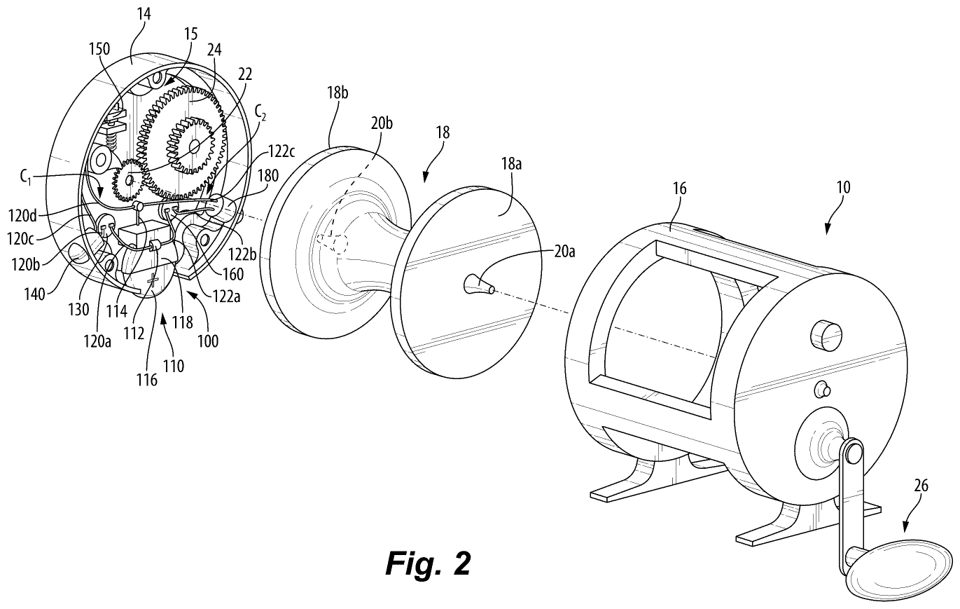

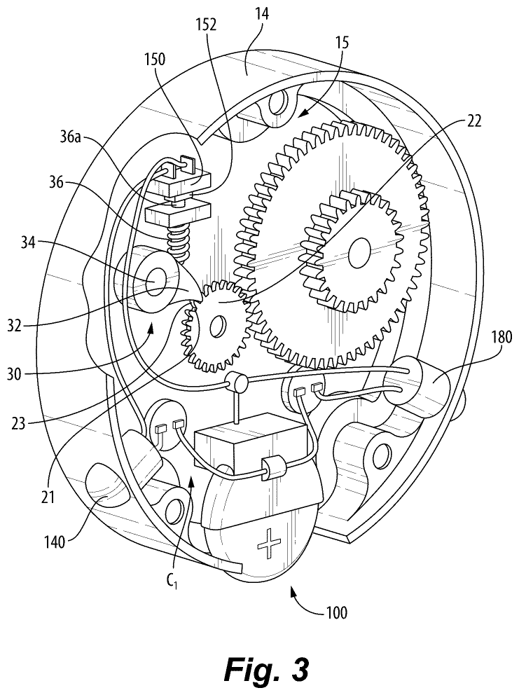

FIG. 1 shows, from a right side perspective, a common variety of fishing reel 10 and rod 12 outfitted with a preferred embodiment of the invention 100, which is located internal to reel side plate 14 (as shown more clearly in FIGS. 2-3). Reel 10 is depicted, by way of example but not limitation, as a commonly-known variety of conventional reels, which are typically designed to allow for the removal of side plate 14 from the reel frame 16 in order to facilitate maintenance, service, or the removal of the reel's spool 18 (FIG. 2) when necessary to change or replace the fishing line 13. In a preferred embodiment, the invention is housed within an internal recess 15 (FIG. 2) provided within side plate 14, so that only control switches 130 and 160, indicator lamp 140, and illumination lamp 180 are visible to the user when the reel is fully assembled or in use.

FIG. 2 shows reel 10 in a partially exploded view from the left side, with side plate 14 removed and additional components of the reel and the preferred embodiment of the illuminating strike indicator 100 of the present invention exposed to view. Spool 18 is equipped on each end 18a, 18b with a respective spool shaft 20a, 20b and a spool gear 22. Spool gear 22 is shown removed from the spool shaft 20b but within the internal recess 15 of side plate 14, which is preferably adapted to conceal the reel's internal mechanical components and the preferred embodiment 100 of the illuminating strike indictor. The reel shown also includes a drive gear 24 engages to the reel's crank mechanism 26 for reeling in fishing line.

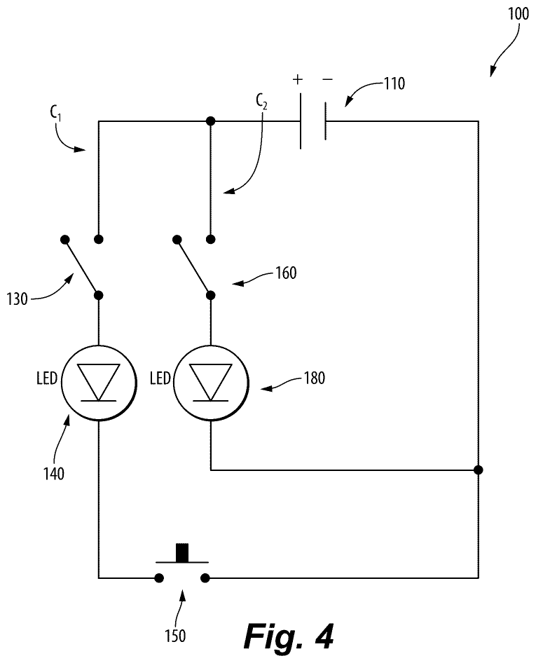

Strike indicator 100 relies on an electrical circuit C₁ (shown in schematic form in FIG. 4) that includes a power source 110 with its positive terminal 112 is connected by lead wire 120a to control switch 130, which is connected by lead wire 120b to strike indicator lamp 140. Lead wire 120c connects indicator lamp 140 to a microswitch 150, which is preferably a push-button type normally-off momentary SPST switch. Lead wire 120d then completes circuit C₁ by connecting the microswitch with the negative terminal 114 of power source 110. In this way, control switch 130, lamp 140, and microswitch 150 are preferably arranged in series along a first circuit path C₁. When the user places control switch 130 in the “on” position, lamp 140 will not illuminate unless microswitch 150, which is typically in its normally “off” position, is placed in its momentarily “on” position. Thus, microswitch 150 controls the illumination of lamp 140.

The embodiment shown includes an optional second circuit path C₂ that is also connected to positive terminal 112 of power source 110 by lead wire 122a and includes, in series, control switch 160 connected by lead wire 122b to a second illumination lamp 180, and returns by lead wires 122c to the negative terminal 114 of power source 110. Circuit paths C₁ and C₂ are preferably arranged parallel to each other between the positive and negative leads of power source 110. In this way, the angler may place control switch 160 into the “on” position to energize path C₂ illuminate lamp 180 whenever additional light is desired or needed without impacting the functions of path C₁. In a preferred embodiment, control switches 130 and 160 are standard pushbutton on-off switches but may be any appropriate style of on-off switch, including toggle, rocker, or illuminated switches.

Lamp 140 is ideally positioned on the reel 10 or the reel's sidewall 14 at a location easily seen by the angler when the lamp illuminates. Similarly, lamp 180 is optimally positioned appropriately to illuminate the area surrounding the rod and reel and, if the lamp is powerful enough, the water's surface near the fishing line.

The embodiment described above and shown in the FIG. 2 utilizes as its power source 110 a small, coin-sized battery 116, such as a CR 2032, and an appropriately-sized battery holder 118. It should be appreciated that while the embodiment described herein relies on basic circuit components to achieve desired illumination, any suitable arrangements for circuit paths C₁ and C₂ bay be substituted, such as a printed circuit board, an appropriately-sized programmed microchip, or other commonly-known electronic devices. Further, additional electrical components such as resistors, capacitors, and the like may be utilized to optimize the brightness of the illumination, length of battery life, or other aspects of the circuit paths.

As described above, when control switch 130 is placed into the “on” position, lamp 140 will not illuminate unless microswitch 150 is placed in its momentarily “on” position. The present invention relies on electromechanical engagement between reel spool 18 and a plunger 152 provided on microswitch 150. Such electromechanical engagement may be achieved in a number of ways to achieve the same result.

With reference to FIG. 3, reel 10 employs a commonly known version of a click mechanism 30 designed to provide an audible alert to the angler when a fish has taken the line. Click mechanism 30 is shown as housed internally within the reel, preferably within side plate recess 15, and includes a pawl 32, a pawl boss 34, about which pawl 32 may rotate, and one or more biasing pins 36 that are biased against one or both sides of the pawl, shown as a spring-loaded pin.

Pawl 30 is shown as engaging with the teeth 23 of spool gear 22. When a fish strikes the fishing line and begins to swim away, spool 18, shaft 20a-b, and spool gear 22 will rotate within the reel frame 16, thus allowing the fishing line to play out. As the spool 18 rotates, the gear teeth 23 defined on spool gear 22 impinge upon pawl 32, forcing it to rotate up and over the gear teeth and press against biasing pin 36, forcing it to slide upwards in response to the movement of the pawl. Bias pin distal end 36a, in turn, pushes upon microswitch plunger 152, forcing microswitch 150 into its momentarily closed position, thereby completing circuit path C₁ and illuminating lamp 140. As the spool continues to rotate, pawl 32 will ride over the top land of the gear tooth 23, and biasing pin 36 will return to its biased position, thus forcing pawl 32 into the valley 21 between adjacent gear teeth. As click pin 36 slides down away from microswitch 150, biasing pin distal end 36a disengages from microswitch plunger 152 allowing the microswitch to return to its normally off position, thus opening circuit C₁ and causing lamp 140 to turn off.

As spool 18 continues to rotate, this process repeats each time the pawl rides up and over the spool gear teeth, thus causing lamp 140 to flash at a rate that is both the same as the rate at which click mechanism clicks and proportional to the rate at which the spool rotates. As the rotation of the spool accelerates in response to fishing line to playing out from the reel, rate of the audible click produced by the click mechanism and the rate at which lamp 140 flashes likewise increases to alert the angler that a fish is on the line. Thus, the interaction of the spool gear 22, pawl 32, biasing pin 36, and microswitch plunger 152 provide an electromechanical engagement that causes lamp 140 to flash as spool 18 rotates within reel frame 16.

It should be appreciated that the present invention is not reliant upon the design of the particular click mechanism 30 shown in FIG. 3. For reels that do not employ pawl pins and rather simply employ a pawl biased toward engagement with spool gear 22, it is envisioned that the invention's electromechanical engagement could be modified such that microswitch 150 is positioned appropriately for pawl 32 to directly impinge upon plunger 152, a thus forcing microswitch 150 into its closed position and closing circuit path C₁ to momentarily illuminate lamp 140. In still other fishing reel arrangements that do not offer a click mechanism, the electromechanical engagement between the click mechanism and circuit path C₁ can be achieved by positioning the microswitch such that its plunger is in direct engagement with the teeth of spool gear 22 such that the rotation of spool and spool gear causes the spool gear teeth to alternately presses upon and releases the microswitch plunger to intermittently close circuit path C₁ and causing lamp 140 to flash.

Additionally, the placement of the power supply, control switch, lamp, and microswitch within the reel as depicted is not critical to the invention, and their positions within the reel may be adapted to accommodate any reel's internal mechanical components, space constraints, or other design considerations. While the description provided above locates each of these components within a recess 15 defined by side plate 14, it should be apparent that the invention can be easily adapted for placement within or outside of other structural members of the reel, including within the reel frame 16 or other structural portions of the reel or external to the reel altogether. Thus, the present invention is easily adaptable to a variety of different styles of reels.

FIG. 4 depicts a schematic of the present invention's electronic circuit paths C₁, C₂. FIG. 4 shows path C₁ arranged such that the positive terminal of power source 110 is connected in series to control switch 130, lamp 140, and microswitch 150 which, in turn, is connected to the negative terminal of power source 110, thus completing path C₁. Path C₂, which is preferably parallel to path C₁, is arranged such that control switch 160 is positioned in series between the positive terminal of power source 110 and lamp 180, which, in turn is connected to the negative terminal of the power source. It should be appreciated that the arrangement of the components is not critical, so long as each component is arranged appropriately for lamp 140 to illuminate whenever control switch 130 is placed into the “on” position and microswitch 150 is placed in a momentarily-closed status. Accordingly, it should also be appreciated that additional circuit components may be utilized to vary the intensity of the illumination of lamps 140, 180, such as one or more resistors or capacitors.

It should be appreciated that the fishing reel described herein is exemplary, as many varieties of reel are currently available, each with their own arrangement of internal mechanical parts. It is envisioned that the placement of the invention's various components can be arranged appropriately to accommodate the space, mechanical, and other design constraints particular to each reel. Further, the invention may be fully integrated into the fishing reel, or offered as an optional replacement part or kit that provides the described utility for reels that do not include the invention as a standard feature.

It should also be understood that the example embodiments described herein should be considered in a descriptive sense only and not for purposes of limitation. Descriptions of features or aspects within each embodiment should typically be considered as available for other similar features or aspects in other embodiments.

I claim:

1. An illuminating strike indicator for fishing reels comprising:
an electrical circuit further comprising:
a power source; and
a first path connected to said power source further comprising a first control switch, a first light source, and an illumination switch in series;
wherein said illumination switch electromechanically engages with a gear provided within the reel that rotates in response to rotation of a spool provided within the reel,
wherein said electromechanical engagement between said illumination switch and the gear provided on the spool alternately closes and opens said first path when said first control switch is in an “on” position.

2. The illuminating strike indicator of claim 1, wherein said first light source is a light-emitting diode.

3. The illuminating strike indicator of claim 1, wherein said illumination switch is a normally open momentary microswitch.

4. The illuminating strike indicator of claim 1, wherein said electrical circuit is housed within a body of the fishing reel.

5. The illuminating strike indicator of claim 1, wherein said electrical circuit is housed within a side plate of the fishing reel.

6. The illuminating strike indicator of claim 1, wherein said electrical circuit further comprises:
a second path parallel to said first path further comprising a second control switch and a second light source in series,
wherein said second light source illuminates continuously while said second control switch is in an “on” position.

7. The illuminating strike indicator of claim 6, wherein said second light source is a light-emitting diode.

8. A fishing reel with an illuminating strike indicator comprising:
a spool for receiving fishing line attached to a spool shaft that rotates within a body of said fishing reel;
a spool gear affixed to said spool shaft;
an electrical circuit further comprising in series:
a power source; and
a first path connected to said power source further comprising, in series a first control switch,
a first light source, and
an illumination switch in electromechanical connection with said spool gear, and
wherein said electromechanical connection between said illumination switch and said spool gear alternately closes and opens said first path of said electrical circuit.

9. The fishing reel of claim 8 wherein said electrical circuit is housed within said body of the fishing reel.

10. The fishing reel of claim 8, wherein said microswitch and said circuit are housed within a sidewall defined by said fishing reel.

11. The fishing reel of claim 10 wherein said illumination switch is a normally open microswitch.

12. The fishing reel of claim 8, wherein said first light source is a light-emitting diode.

13. The fishing reel of claim 8, wherein said electrical circuit further comprises:
a second path parallel to said first path further comprising a second light source and a second on-off switch,
wherein said second light source illuminates continuously while said second control switch is in an “on” position.

14. The fishing reel of claim 13, wherein said second light source is a light-emitting diode.

15. A fishing reel with an illuminating strike indicator, said fishing reel comprising:
a body;
a spool adapted for receiving a fishing line;
a click mechanism for providing an audible clicking sound when a fish strikes said fishing line and said spool rotates within said body; and
a light source that provides a flashing light effect as said spool rotates within said body;
wherein the audible clicking sound and the flashing light effect occur at a rate proportional to a rate at which said spool rotates within said body of said fishing reel.

16. The fishing reel of claim 15, wherein said first light source is a light-emitting diode.

17. The fishing reel of claim 15 further comprising a circuit for controlling said flashing light effect of said light source, said circuit further comprising in series with said light source:
a power source;
a first on-off switch; and
an illumination switch in electromechanical connection with said click mechanism.

18. The fishing reel of claim 16 wherein said illumination switch is normally open microswitch.

19. The fishing reel of claim 17, wherein said circuit is housed within a sidewall defined by said fishing reel.

20. The fishing reel of claim 17, wherein said electrical circuit further comprises a second light source and a second on-off switch,
wherein said second light source illuminates continuously while said second control switch is in an “on” position.
